(19) United States
(12) Patent Application Publication
(10) Pub. No.: US 2012/0316991 A1
(43) Pub. Date: Dec. 13, 2012

(54) Evaluating Merchant Trustworthiness

(75) Inventor: Thomas Mackenzie Fallows, San Francisco, CA (US)

(73) Assignee: GOOGLE INC., Mountain View, CA (US)

(21) Appl. No.: 13/247,966

(22) Filed: Sep. 28, 2011

Related U.S. Application Data
(63) Continuation of application No. 13/157,269, filed on Jun. 9, 2011.

(51) Int. Cl. G06Q 30/00

(52) U.S. Cl. 705/26.35

(57) ABSTRACT

Merchants are classified according to their reliability in shipping purchased products when promised. A merchant trustworthiness evaluator (MTE) automatically gathers data from users about purchases online from a merchant, including an order identifier and an estimated ship date. In one embodiment, the MTE collects data from customers about their purchases through the use of a conversion pixel, transmitted to the customer by the merchant at the time of purchase. The MTE obtains shipment information from the merchant or shipment carrier once an order has been shipped. The MTE correlates the shipment data with the order data and compares for each order the estimated or promised and actual shipment dates. The MTE scores merchants and classifies each merchant based on its score. Merchant classifications can then be provided to prospective customers.

### CROSS-REFERENCE TO RELATED APPLICATIONS

This application is a continuation of U.S. patent application Ser. No. 13/157,269, filed on Jun. 9, 2011, and incorporated by reference in its entirety.

### BACKGROUND

1. Field

Described embodiments concern the evaluation of merchants involved in online commerce. In particular, described embodiments are directed to gathering and analyzing historical shipping and customer service data relating to online merchants for the purpose of evaluating the trustworthiness of those merchants.

2. Description of the Related Art

While online shopping has continued to be a popular form of commerce, customers and merchants alike are frustrated by its anonymity. Excellent, reliable merchants are unable to easily signal their quality to potential customers. Meanwhile, customers who are able to make price comparisons across online merchants struggle to ascertain reputability at the same time.

Typical attempts to solve this problem focus on manual mechanisms of evaluating merchants. Often, buyers can rate merchants within online buying platforms, and the aggregate buyer feedback is displayed to customers. Alternatively, buyers can register complaints with organizations like the Better Business Bureau (BBB), and online buying platforms can monitor that data on behalf of customers.

### SUMMARY

Described embodiments enable classification of online merchants according to their reliability in shipping purchased products when promised. A merchant trustworthiness evaluator (MTE) gathers data from users about purchases online from a merchant. In one embodiment, the MTE collects data from customers about their purchases through the use of a conversion pixel, transmitted to the customer by the merchant at the time of purchase. The information collected includes the merchant's estimated shipping date, the customer's Internet protocol (IP) address, and the order number. Additional information, such as an estimated delivery date and estimated shipment weight may also be collected by the MTE.

The MTE additionally gathers data from online merchants. In one embodiment, merchants provide tracking information for shipped orders at regular intervals to the MTE. This information may include order numbers, their corresponding shipment tracking numbers, ship dates, and the zip codes to which orders are shipped. In some embodiments, the information is provided in batch by the merchant, for example on a daily basis, while in other embodiments the information is provided to the MTE in real time when a product is tendered by the merchant to a shipment carrier.

The MTE correlates the order shipment information received from merchants with the purchase information received from users and automatically monitors the progress of shipments. In one embodiment, the MTE uses tracking numbers received from merchants to track shipment progress and automatically compares actual dates of shipment to the online merchant's stated estimated date of shipment.

In one embodiment, the MTE performs an antifraud analysis to reduce opportunities for gamesmanship by merchants. Such techniques may include matching postal codes of package destinations to geolocations of IP addresses; comparing tracked package weights to known or estimated weights of the products being shipped in those packages; comparing package origin locations with known or estimated warehouse locations of the products being shipped in those packages; and identifying mal-formed or invalid tracking numbers.

The MTE evaluates the trustworthiness of a merchant by scoring the merchant on historical shipping performance metrics. In various embodiments, these metrics include how frequently the merchant tendered orders to shipment carriers by the estimated or promised date and whether the shipment carrier delivered the order to the destination address on, before or after the estimated date. The MTE passes these metrics through an evaluation engine to determine whether or not the MTE should be designated as trustworthy. Merchants determined to be trustworthy can then be highlighted or otherwise identified to potential customers as part of their online shopping experience.

### BRIEF DESCRIPTION OF THE DRAWINGS

FIG. 1 is an illustration of a system for evaluating the trustworthiness of online merchants in accordance with one embodiment.

FIG. 2 is a flowchart illustrating a method for updating merchant profile data in accordance with one embodiment.

FIG. 3 is a flowchart illustrating a method for evaluating online merchants in accordance with one embodiment.

The figures depict embodiments for purposes of illustration only. One skilled in the art will readily recognize from the following discussion that alternative embodiments of the structures and methods illustrated herein may be employed without departing from the principles described herein.

### DETAILED DESCRIPTION

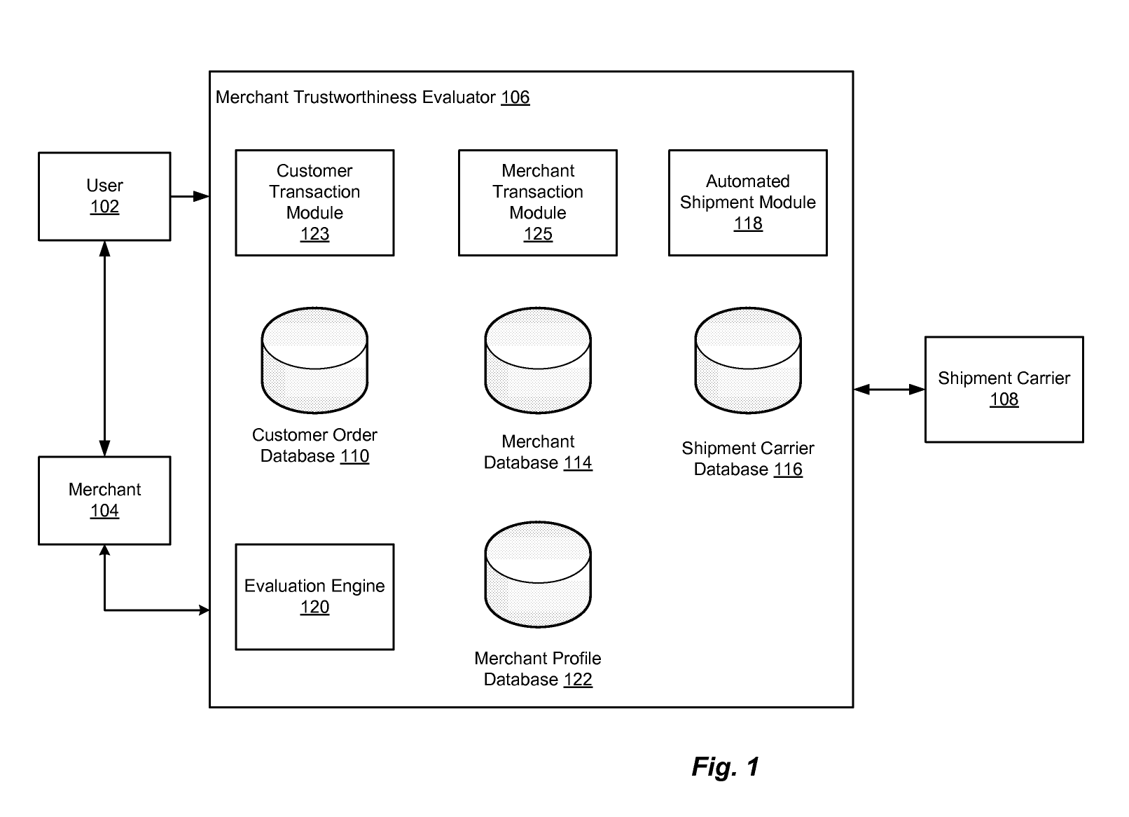

FIG. 1 is a block diagram of a merchant trustworthiness evaluator (MTE) system for evaluating the trustworthiness of online merchants in accordance with one embodiment. MTE 106 includes several databases and modules, including customer order database 110, merchant database 114, shipment carrier database 116, automated shipment module 118, evaluation engine 120, customer transaction module 123, merchant transaction module 125, and merchant profile database 122. Each of these is described further below. FIG. 1 also includes user computer 102, merchant 104, and shipment carrier 108. Although for clarity only one user computer 102, merchant 104, and shipment carrier 108 are illustrated, large numbers of each may be present in various embodiments.

User computer 102 is used by a customer who engages in an electronic commerce transaction, such as a purchase of a good or service. User computer 102 can be a laptop, desktop, cell phone, handheld device, thin or thick client device, video appliance, or any other appropriate computing platform, and transactions may be made using the Internet, cellular network, or any other suitable communications network. The user operating user computer 102 can be an individual, group of individuals, corporate entity, or automated computer system.

Merchant 104 is an individual, group of individuals, corporate entity, or automated computer system that provides goods or services for purchase through electronic commerce transactions, for example using a web site.

For ease of description, we refer generally to a “user”, and those of skill will recognize that this includes either the user (customer) herself, the user's computer system, or the combination of the two, as may be appropriate in context. We make similar use of the term “merchant”.

MTE 106 is an automated computer system administered by an individual, group of individuals, corporate entity, or automated computer system that collects order data and shipment data in connection with the purchase described above in order to evaluate merchants 104 and make a determination of their trustworthiness. One example of an MTE 106 provider is Google Inc., of Mountain View, Calif. Using the collected information, MTE 106 determines whether a merchant 104 should be designated as trustworthy by, for each of a plurality of orders from the merchant, comparing promised ship dates and shipment arrival times with actual ship dates and arrival times.

The interval between when a customer places an order with an online merchant and when the customer receives physical delivery of the order can be separated into two sub-intervals: first, a time between when the merchant receives the order and when the merchant ships the order; and second, a time between when the order is tendered to a shipper and when the shipper delivers the order to the specified shipping address.

In some embodiments, merchants are evaluated based on when they tender orders to the shipment carrier. In alternative embodiments, merchants are additionally evaluated based on when the shipment carrier delivers the order to the destination address. Although merchants may have less influence over the shipment once it has been tendered to the shipper, including the actual delivery date in the merchant evaluation prevents the merchant from escaping detection by, for example, choosing a different delivery option such as ground shipping, while charging the purchaser for a premium shipping option such as overnight air.

In various embodiments, merchants 104 display an estimated shipment date to users 102 as part of the product advertisement or transaction process. In some embodiments, a user is offered some measure of influence over the shipment date at purchase time, for example by paying an additional fee to the merchant for expedited processing; in other embodiments, the estimated shipment date is determined entirely by the merchant 104. Similarly, in some embodiments, users 102 are able to specify some combination of shipper and shipment method, e.g., overnight courier, standard mail, etc., that will impact the estimated time in transit of the shipment. In other embodiments, the merchant 104 determines the choice of carrier 108 and level of service. Ultimately, the user 102 is given an indication by the merchant 104 of either when the order is expected to be tendered to the shipper 108, when it is expected to be delivered to the user 102, or both.

In one embodiment, when user 102 completes a purchase transaction with merchant 104, user 102 communicates information about the transaction to customer transaction module 123 of MTE 106. In one embodiment, this information includes the Internet protocol (IP) address of user 102, order indicia such as an order number generated by merchant 104, and estimated shipping date provided to user 102 by by the merchant 104. In one embodiment, this information is provided by merchant 104 to user 102 through the use of a conversion pixel embedded into the order confirmation page displayed by merchant 104 to user 102. The conversion pixel then causes the user's browser to convey the transaction information to customer transaction module 123, which stores the received information in customer order database 110. In some embodiments, additional information is also conveyed to the MTE 106 via conversion pixel or other reporting mechanism, including indicia of the product(s) ordered, price paid for the product, price paid for shipping, estimated ship weight, estimated delivery date, etc.

Merchants 104 provide shipment information to merchant transaction module 125, either in real time or in periodic batches. Since there is generally a delay between when a transaction is made and when a shipment is tendered to shipment carrier 108, the order information is typically received from user 102 hours, days, or weeks prior to the shipment information being received for that order from merchant 104. In one embodiment, shipment information received from merchant 104 includes an order number, shipment carrier identification, and shipper tracking number. In some embodiments, shipment information also includes delivery information such as a complete delivery address, or alternatively an approximate delivery location such as city and state, postal code, etc., and shipment weight. Merchant transaction module 125 stores the received shipment information in merchant database 114. In an alternative embodiment, the shipment information is received from shipment carrier 108 rather than merchant 104. In another embodiment, the shipment information is provided to the user 102, who in turn provides it to MTE 106, e.g., by forwarding an e-mail, or through a beacon in a notification e-mail sent from merchant 104 to customer 102.

Tracking numbers are identifiers generated by shipment carriers for each shipment handled by the carrier. Tracking numbers are typically provided by the carrier 108 to the sender of the shipment—in this case, the merchant, and merchants often forward tracking numbers to purchasers so that they can observe the progress of individual packages handled by shipment carrier 108. Automated shipment module 118 accesses tracking information provided by shipment carrier 108 to confirm shipment and arrival dates for shipments as described further below. In one embodiment, shipment carrier 108 provides an API or other mechanism through which shipment module 118 obtains the tracking information. In one embodiment, shipment carrier 108 provides periodic status reports for each tracking number of interest to merchant transaction module 125. Tracking numbers include details such as a package's actual date and time of shipment, its location while in transit, its actual date and time of delivery, the specific or approximate locations of the package's origin and destination, and the weight of the package. In one embodiment, after merchant transaction module 125 receives a tracking number from merchant 104, automated shipment module 118 begins querying shipment carrier 108 for shipment information associated with the tracking number. MTE 106 automatically collects data related to that tracking number from shipment carrier 108 and stores it in shipment carrier database 116.

Once merchant transaction module 125 receives a set of tracking numbers and associated order numbers, evaluation engine 120 matches the order numbers with those stored in customer order database 110. Evaluation function module 120 scores merchants 104 based on a comparison of promised or estimated ship dates and actual outcomes. In one embodiment, merchants are evaluated with respect to when an order was tendered to the shipment carrier; in an alternative embodiment, evaluations are also based on when the order was delivered by the shipper to the destination address.

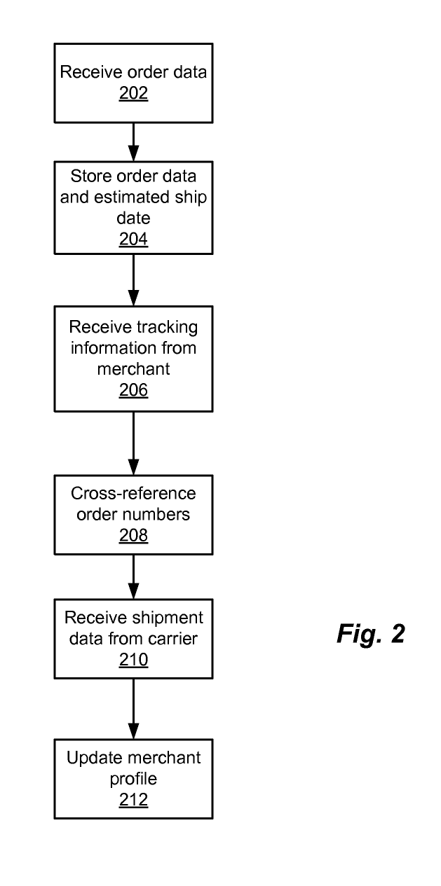

FIG. 2 illustrates a method for updating merchant profile data in accordance with one embodiment. Customer transaction module 123 receives 202 order data from user 102 upon completion of a transaction. As noted, the order data includes an order number or other indicia sufficient to uniquely identify the order, and includes at least one of an estimated ship date and estimated delivery date. Customer transaction module 123 then stores 204 the order data and shipment information in customer orders database 110. At some subsequent time, merchant transaction module 125 receives 206 an indication from merchant 104 indicating that the order has shipped. As noted, this may be in the form of a batch report of orders that have shipped since the past report, e.g., a daily shipping log. Automated shipment module 118 cross-references 208 the order number received from the merchant with the order numbers stored in customer order database 110 to identify the order that has been shipped. The indication includes the order number or other order-identifying indicia, as well as a tracking number or other indicia sufficient to identify the shipment with shipment carrier 108. Automated shipment module 118 then obtains 210 shipment data from carrier 108 using the tracking number received from merchant 104. Automated shipment module 118 may query shipment carrier 108 periodically, e.g., daily, weekly, etc., to determine when the shipment has been delivered. Once the shipment has been delivered, automated shipment module 118 updates 212 a merchant profile for the merchant 104 in merchant profile database 122 to reflect performance data for the order including the estimated and actual ship date and delivery date.

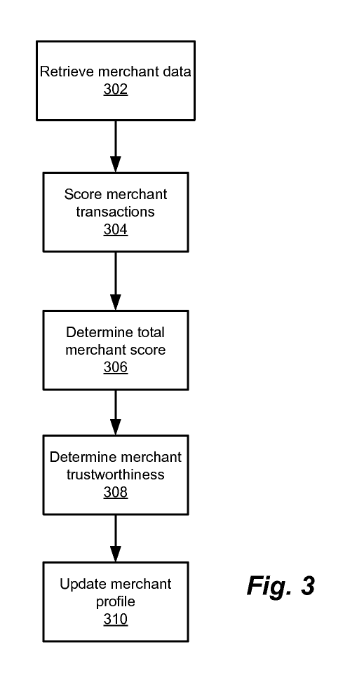

FIG. 3 illustrates a method for evaluating a merchant in accordance with one embodiment. As described above with respect to FIG. 2, shipment data is collected for each order fulfilled by the merchant 104, and the merchant's profile is updated to include performance data. To evaluate a merchant, evaluation engine 120 retrieves 302 merchant data from merchant profile database 122. The merchant data includes indicia of an estimated ship date and an actual ship date for each tracked order fulfilled by the merchant 104. In some embodiments, the merchant data also includes an estimated delivery date and an actual delivery date. Evaluation engine 120 then scores 304 each order according to a scoring function. In one embodiment, a merchant is awarded a score for meeting the ship date estimate, and receives no points for missing the deadline. In an alternative embodiment the scoring function awards a number of points to the merchant for tendering the shipment to the shipper on the estimated ship date, and decays the number of points awarded according to a decay function for each day of delay. In one embodiment, points are added to the baseline number for each day in advance of the promised ship date the merchant tendered the shipment. In embodiments where the merchant is evaluated based on delivery date to the customer, a similar scoring function is applied. In some embodiments, the score awarded based on tender date is weighted relative to the score awarded based on delivery date, to increase or decrease the significance of each measure according to the preference of the implementer.

Once each transaction is scored, the total merchant score is determined 306 by averaging across all transactions. In some embodiments, the score is further normalized to account for variations such as total number of orders processed. The total merchant score is then used to determine 308 the level of trustworthiness to be associated with the merchant. In one embodiment, any merchant who exceeds a threshold score—which may be set by the implementer—is determined to be trustworthy, while those merchants falling short of the score do not receive the trustworthy designation. In other embodiments, score bands are used to assign particular levels of trustworthiness to merchants. These bands may be, for example, percentiles, letter grades, qualifiers such as “good,” “very good,” “poor,” etc., or any other suitable label that quantitatively or qualitatively differentiates among scored merchants. The merchant profile is then updated 310 to reflect the assigned level of trustworthiness.

In one embodiment, MTE 106 incorporates a fraud detection analysis as part of the merchant evaluation process. For example, a merchant 104 may attempt to skew the results of the evaluation by placing a high volume of false orders and then immediately shipping empty or near-empty packages that correspond to the false order number to inflate its trustworthiness rating. In one embodiment, evaluation engine 120 reviews the shipment weight for each shipment obtained from shipment carrier 108. In one embodiment, shipments with a weight below a certain value are not considered in the evaluation process. In one embodiment, order information received from user 102 includes the shipping weight of the purchased product, e.g., in the conversion pixel, and evaluation engine 120 compares the shipping weight in the order information to the shipment weight obtained from the carrier to confirm the legitimacy of the order, ignoring transactions with mismatches greater than a particular amount or percentage, as may be specified by the implementer. In one embodiment, shipping weight can be estimated if the order information includes the product description, based on commercially available information regarding the shipping weight of commercial products. In one embodiment, evaluation engine 120 compares the geographical location of the IP address associated with the user 102 who placed the order with the delivery postal code obtained from shipment carrier 108, and assigns a higher score to transactions where the two locations are within a threshold distance of each other. The threshold distance may be set at, for example 25 miles, or may be adjusted by the implementer. Obtaining a location based on an IP address can be performed using traditional methods of IP geolocation. In various embodiments, the weight assigned based on a particular fraud detection algorithm is adjustable. For example, merchants such as florists frequently deliver gifts to addresses other than the address of the customer placing the order, and an implementer may choose to reduce the weight of the IP-to-postal-code comparison performed for that class of merchants.

In one embodiment, evaluation engine updates the trustworthiness score of a merchant periodically, enabling a merchant 104 to reclaim trustworthy status that it may have lost, as well as removing that status from merchants with deteriorated performance metrics. In one embodiment, a merchant's score is decayed such that the merchant's recent performance, e.g., within the previous 90 days, has more influence on the score than does older performance.

Once merchants have been assigned a trustworthiness score, information about the score can be conveyed to consumers as part of the shopping experience. For example, a merchant 104 that has obtained a score from MTE 106 may display (or have displayed on its behalf by MTE 106) indicia of the score—such as the score itself, or a rating associated with the score—on its web site, or in ads placed on other web sites such as search engine sites. Alternatively, an online shopping aggregation site, which displays a list of merchants from whom a particular product is available, can indicate next to some or all merchants what score or rating has been assigned by MTE 106 to those merchants. In some embodiments, MTE 106 may itself be the online shopping aggregation site. In alternative embodiments, MTE 106 makes scores or ratings available to merchants, online shopping aggregation sites, search engines, and/or the public at large, and in some embodiments does so for free, and in alternative embodiments does so for a fee. In some embodiments, merchants display indicia of their score through media other than the Internet—for example, via television and radio commercials, in-store displays, and newspaper advertisements.

The present invention has been described in particular detail with respect to a limited number of embodiments. Those of skill in the art will appreciate that the invention may additionally be practiced in other embodiments.

Within this written description, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component. For example, the particular functions of automated shipment module 118, evaluation engine 120, and so forth may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “collecting” or “evaluating” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method for scoring merchant performance, the method comprising:
for each of a plurality of transactions, each transaction between a customer and one of a plurality of merchants and conducted over a computer network:
receiving, from the customer and by a computer, customer order data, the customer order data including an order identifier and an estimated ship date;
receiving, by the computer, merchant data, the merchant data including the order identifier and shipment information;
determining, by the computer and using the shipment information, an actual ship date;
determining, by the computer, a difference between the estimated ship date and the actual ship date;
scoring, by the computer, each of the plurality of merchants according to the determined difference between the estimated ship date and the actual ship date for each of the plurality of transactions including the merchant; and
storing classification indicia for each merchant in a merchant profile database, the classification determined according to the merchant's score.

2. The method of claim 1 wherein the customer order data is received via a conversion pixel.

3. The method of claim 1 wherein customer order data includes an IP address associated with the customer.

4. The method of claim 3 further comprising:
determining a geographic area associated with the IP address;
determining from the shipment information a delivery location;
responsive to a distance between the geographic area and the delivery location not exceeding a threshold distance, incrementing the merchant score.

5. The method of claim 1 wherein customer order data includes a predicted shipment weight.

6. The method of claim 5 further comprising:
determining from the shipment information a shipment weight;
responsive to a difference between the shipment weight and the predicted shipment weight not exceeding a threshold difference, incrementing the merchant score.

7. The method of claim 1 wherein the customer order data includes an estimated delivery date, and further comprising:
determining using the shipment information an actual delivery date;
wherein scoring each merchant further comprises scoring each merchant according to a determined difference between the estimated delivery date and the actual delivery date.

8. The method of claim 7 wherein the shipment information includes a shipment tracking number and determining the actual delivery date further comprises:
providing the shipment tracking number to a shipment carrier; and
receiving from the shipment carrier the actual delivery date.

9. The method of claim 1 wherein the shipment information includes a shipment tracking number.

10. The method of claim 9 wherein determining the actual ship date further comprises:
providing the shipment tracking number to a shipment carrier; and
receiving from the shipment carrier the actual ship date.

11. The method of claim 1 wherein the merchant data is received from the merchant.

12. The method of claim 1 wherein the merchant data is received from a shipment carrier.

13. The method of claim 1 wherein storing classification indicia for the merchant further comprises:
responsive to the merchant's score exceeding a threshold score, classifying the merchant according to a first classification.

14. The method of claim 13 wherein storing classification indicia for the merchant further comprises:
responsive to the merchant's score not exceeding a threshold score, classifying the merchant according to a second classification.

15. The method of claim 1 further comprising:
receiving a request for a merchant's classification;
retrieving the stored classification indicia associated with the merchant; and
providing the retrieved indicia in response to the request.

16. A computer program product for scoring merchant performance, the computer program product stored on a non-transitory computer-readable medium and including instructions configured when loaded into memory to cause a processor to perform steps comprising:
for each of a plurality of transactions, each transaction between a customer and one of a plurality of merchants:
receiving customer order data, the customer order data including an order identifier and an estimated ship date;
receiving merchant data, the merchant data including the order identifier and shipment information;
determining using the shipment information an actual ship date;
determining a difference between the estimated ship date and the actual ship date;
scoring each of the plurality of merchants according to the determined difference between the estimated ship date and the actual ship date for each of the plurality of transactions including the merchant; and
storing classification indicia for each merchant, the classification determined according to the merchant's score.

17. A merchant trustworthiness evaluator system, comprising:
a processor;
a merchant profile database, coupled to the processor, configured to store merchant profile data for a plurality of merchants;
a customer transaction module, coupled to the processor, for receiving order data from a customer upon completion of a transaction between the customer and a merchant, the order data including indicia identifying the order and an estimated ship date;
a customer orders database, coupled to the customer transaction module, for storing the order data;
a merchant transaction module, coupled to the customer orders database, for receiving an indication from the merchant that the order shipped on a shipping date, the indication including a shipment tracking number;
an automated shipment module, coupled to the merchant transaction module, configured to obtain shipment data from a shipment carrier using the shipment tracking number and, responsive to an indication that the order was delivered to the customer on a delivery date, to update a merchant profile for the merchant and store the updated profile in the merchant profile database; and
an evaluation engine, coupled to the merchant profile database, configured to determine a score for the order based on the estimated ship date, the shipping date, and delivery date, and to update the merchant profile to include the determined score for the order.
